(19) United States
(12) Patent Application Publication
(10) Pub. No.: US 2022/0185229 A1
(43) Pub. Date: Jun. 16, 2022

(54) SEAT BELT DEVICE FOR VEHICLE

(71) Applicant: HONDA MOTOR CO., LTD., Tokyo (JP)

(72) Inventors: Kensuke KIMURA, Tokyo (JP); Yusuke OGATA, Tokyo (JP); Mitsuru NAKANO, Tokyo (JP); Hiroaki AZUMI, Tokyo (JP); Hidenori Watanabe, Utsunomiya-shi (JP); Kenta Oguma, Utsunomiya-shi (JP); Hirokazu Kobayashi, Nagoya-shi (JP)

(21) Appl. No.: 17/548,949

(22) Filed: Dec. 13, 2021

(30) Foreign Application Priority Data
Dec. 15, 2020 (JP) 2020-207841

(51) Int. Cl. B60R 22/26; B60R 22/22

(52) U.S. Cl. CPC B60R 22/26; B60R 2022/1806; B60R 22/22

(57) ABSTRACT

A seat belt device for a vehicle includes: a seat provided with a seatback and a seat cushion, and mounted on a floor panel; a buckle arranged at a lower edge of the seatback and coupled to a tongue member of a seat belt; a webbing having a base end thereof fixed to the floor panel, and a tip end thereof coupled to the buckle through between the seatback and the seat cushion; and a fixing band member arranged along a seat surface of the seatback. The fixing band member is provided with an auxiliary band member having the loop through which the webbing, coupled with the buckle at the tip end of the webbing, is inserted. The buckle inserted through the loop is held at an initial position by the auxiliary band member.

### CROSS-REFERENCE TO RELATED APPLICATION

The present application claims the benefit of priority to Japanese Patent Application No. 2020-207841 filed on Dec. 15, 2020, the disclosures of all of which are hereby incorporated by reference in their entireties.

### TECHNICAL FIELD

The present disclosure relates to a seat belt device for a vehicle.

### BACKGROUND

Conventionally, there has been a seat belt device for a vehicle, including a buckle-housing recess, opening upward, provided in a seat cushion, which is supported by a vehicle body floor, and a buckle connected to the vehicle body floor via a webbing (Japanese Patent Application Publication No. 2013-67344, for example).

The buckle is inserted through a ring-shaped rubber band and inserted into a slit-shaped buckle insertion part, so as to be housed in the buckle-housing recess.

With the conventional seat belt device for a vehicle as described above, the rubber band holding the webbing may be stretched and contracted when the buckle is operated, to have the buckle displaced along the webbing. When a seat is adjusted (dive-down, for example) in this condition and then restored, the buckle may be hidden between a seatback and the seat cushion.

The present disclosure is intended to provide a seat belt device for a vehicle to keep holding a buckle at an initial position.

### SUMMARY

A seat belt device for a vehicle of the present disclosure includes: a seat provided with a seatback and a seat cushion, and mounted on a floor; a buckle arranged at a lower edge of the seatback and coupled to a tongue member of a seat belt; a webbing having a base end thereof fixed to the floor, and a tip end thereof coupled to the buckle through between the seatback and the seat cushion; a fixing band member arranged at a lower end of the seatback; and an auxiliary band member arranged on the fixing band member and having the webbing, coupled to the buckle, inserted therethrough.

The present disclosure provides a seat belt device for a vehicle to keep holding a buckle at an initial position.

### BRIEF DESCRIPTION OF THE DRAWINGS

FIG. 1 is a front view of a seat, arranged in an interior of a vehicle, of a seat belt device for a vehicle according to an embodiment of the present disclosure;

FIG. 2 is a plan view of an auxiliary band member and a fixing band member of the seat belt device for a vehicle of the present embodiment, as viewed from an arrow III in FIG. 1;

FIG. 3 is a side view of a webbing, connected to a buckle, and the auxiliary band member of the seat belt device for a vehicle of the present embodiment;

FIG. 4 is a perspective view of the seat belt device for a vehicle of the present embodiment, illustrating the buckle being pulled out forward, with reference to the vehicle, from between a seatback and a seat cushion; and

FIG. 5 is a plan view of an auxiliary band member and the fixing band member, at a position corresponding to that illustrated in FIG. 2, of a modification of the seat belt device for a vehicle of the present embodiment.

### DETAILED DESCRIPTION

Next, a description is given in detail of an embodiment of the present disclosure, with reference to the drawings as appropriate. The same components are denoted by the same reference symbols and duplicate descriptions thereof are omitted. When directions are referred to, they are basically based on front/rear, right/left, or up/down, as viewed by a driver, unless otherwise indicated. Further, a “width direction” is equivalent to the “right/left direction.

First, a description is given of a structure of a seat belt device for a vehicle of the present embodiment.

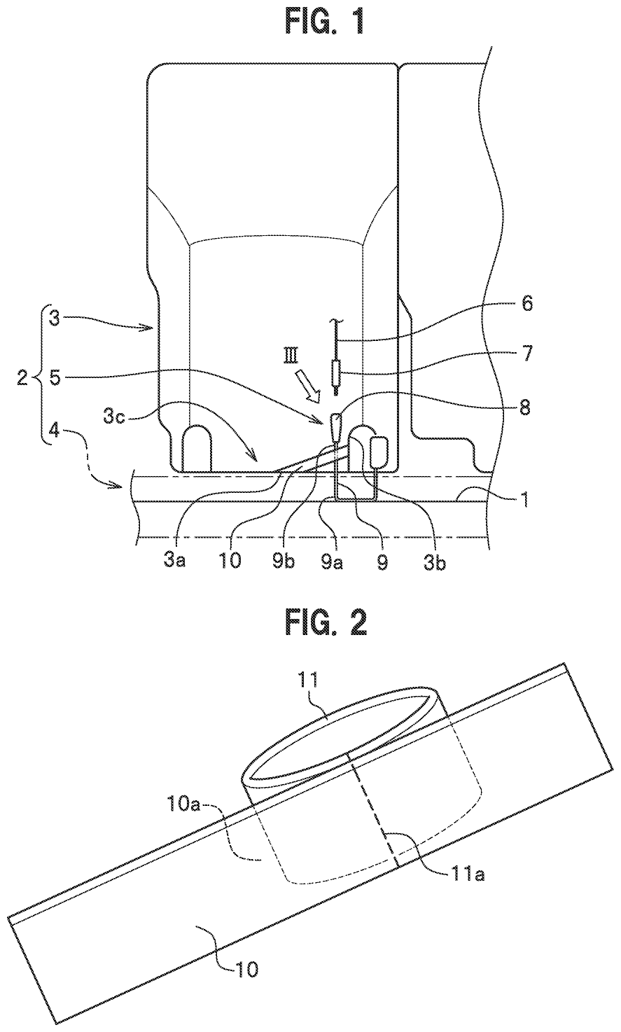

As illustrated in FIG. 1, a seat 2 is mounted on an upper side of a floor panel 1 in an interior of a vehicle. The seat 2 includes a seatback 3 and a seat cushion 4, and is configured to be foldable for storage, with a front surface of the seatback 3 and an upper surface of the seat cushion 4 facing each other. Further, the seat 2 includes a seat belt device 5 to restrain a seated occupant. Note that, for the purpose of illustration, the seat cushion 4 is drawn with an imaginary line (double-dotted chain line) in FIG. 1.

The seat belt device 5 of the present embodiment includes a buckle 8 arranged at a lower edge 3a of the seatback 3. The buckle 8 has a tongue member 7 detachably coupled thereto.

The seat belt device 5 includes a webbing 9 to couple the buckle 8 to the floor panel 1.

The webbing 9 is made of a bendable fabric material as approximately the same as that of a seat belt 6. The webbing 9 has a base end 9a fixed to the floor panel 1 via an anchor member. Further, the webbing 9 has a tip end 9b pulled out above a seat surface of the seat 2 through between the seatback 3 and the seat cushion 4, and coupled to the buckle 8.

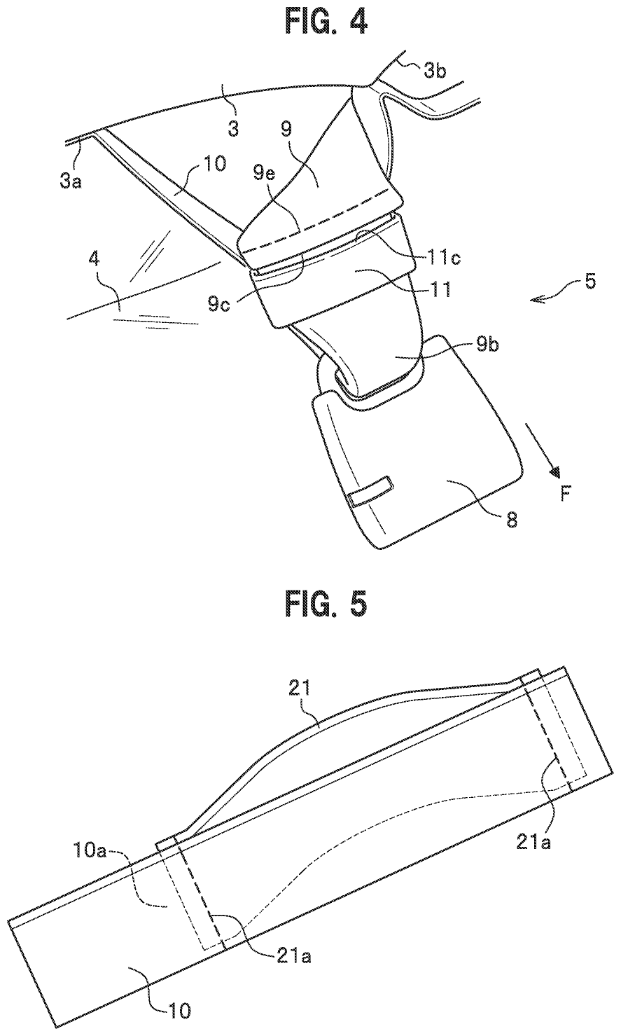

The seat belt device 5 of the present embodiment needs to hold the buckle 8 at a position and in an orientation for easy connection with the tongue member 7 (with an insertion opening for the tongue member facing upward, also referred to as an initial position, hereinbelow). For this purpose, the seat belt device 5 is provided with a fixing band member 10 and an auxiliary band member 11 for holding the buckle 8 at the lower edge 3a (see FIG. 4) of the seatback 3.

As Illustrated in FIG. 1, the fixing band member 10 extends upward at an angle along a seat surface 3c of the seatback 3 from the lower edge 3a to a periphery of a recess 3b, where a rotation shaft of the seatback 3 is laterally inserted. Further, the fixing band member 10 is made of a rubber band having elasticity.

The fixing band member 10 is fixed by stitching one end thereof to the lower edge 3a and the other end thereof to the periphery of the recess 3b. This allows the fixing band member 10 to hold the buckle 8 near a lower end of the seatback 3 (see FIG. 4).

As illustrated in FIG. 2, an auxiliary band member 11 is provided at the middle position in a longitudinal direction of the fixing band member 10. The auxiliary band member 11 has a band-shaped member having a predetermined width formed in a loop shape, through which the buckle 8 and webbing 9 are inserted. The auxiliary band member 11 is partially stitched at a stitched part 11a so as to be fixed to a seatback-facing surface 10a of the fixing band member 10.

The loop of the auxiliary band member 11 in the present embodiment is sized to inhibit the buckle 8 from falling off while the buckle 8 and webbing 9 are inserted therethrough (see FIG. 4).

Further, the auxiliary band member 11 is formed to have a width dimension approximately being the same as or narrower than that of the fixing band member 10. Therefore, the auxiliary band member 11 is covered by the fixing band member 10 and is not easily seen from outside. Still further, the auxiliary band member 11 is made of a fabric material having less elasticity than the fixing band member 10, for example.

The webbing 9 coupled to the buckle 8 is inserted through the loop of the auxiliary band member 11, to hold the buckle 8 at the initial position (see FIG. 1).

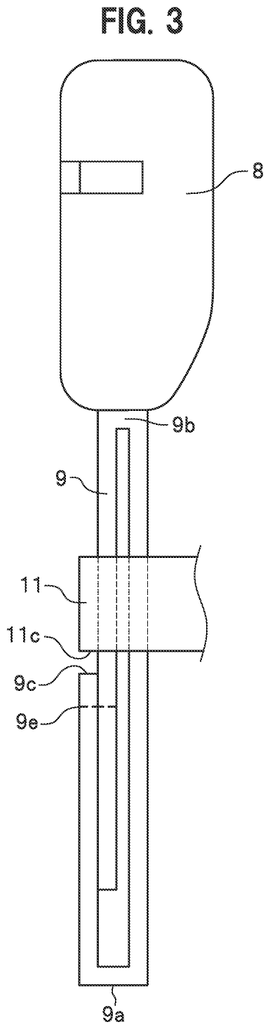

As illustrated in FIG. 3, the seat belt device for a vehicle of the present embodiment has the webbing 9 folded multiple times in the longitudinal direction, and a two-fold or a three-fold part is stitched at a stitched part 9e. This gives the webbing 9 desired strength.

The stitched part 9e has a stitched end 9c located at the middle of the webbing 9, with a stepped end surface facing toward the buckle 8.

Further, the auxiliary band member 11 is arranged between the buckle 8 and the stitched end 9c. Accordingly, a side edge 11c of the auxiliary band member 11 is arranged to face an end surface of the stitched end 9c.

Supposing that the auxiliary band member 11 is slidably moved from the tip end 9b to the base end 9a of the webbing 9, for example. In this case, the side edge 11c comes in contact with the stepped end surface of the stitched end 9c so that sliding movement of the auxiliary band member 11 is stopped.

As illustrated in FIG. 1, the seat belt device 5 for a vehicle of the present embodiment includes: the seat 2 provided with the seatback 3 and the seat cushion 4, and mounted on the floor panel 1; the buckle 8 arranged at the lower edge 3a of the seatback 3 and coupled to the tongue member 7 of the seat belt 6; the webbing 9 having the base end 9a fixed to the floor panel 1, and the tip end 9b coupled to the buckle 8 through between the seatback 3 and the seat cushion 4; and the fixing band member 10 arranged along the seat surface of the seatback 3.

Further, as illustrated in FIG. 2, the fixing band member 10 is provided with the auxiliary band member 11 having the loop through which the webbing 9, coupled with the buckle 8 at the tip end 9b of the webbing 9, is inserted. The buckle 8 inserted through the loop is held at an initial position by the auxiliary band member 11.

The seat belt device for a vehicle of the present embodiment holds the buckle 8 at an initial position (see FIG. 1).

Specifically, the buckle 8 is coupled to the tip end 9b of the webbing 9 which is inserted through the auxiliary band member 11. The auxiliary band member 11 is provided on the fixing band member 10 along the seat surface 3c of the seatback 3.

Therefore, when the seat 2 is folded, the buckle 8 follows the folding, along with the webbing 9, so that the buckle 8 is not displaced. Accordingly, the buckle 8 does not fall off from between the seatback 3 and the seat cushion 4 onto the floor panel 1.

Then, when the seat 2 is restored to a seating position, the buckle 8 returns to an initial position at the lower edge 3a of the seatback 3.

Thus, even when the seat 2 is moved with the folding, there is no risk of the buckle 8 falling off. Therefore, the device reduces a risk of the buckle 8 being caught between a seat leg and the floor panel 1 or between a seat hinge and another buckle 8, when the seat is unfolded.

Further, when fallen off from the fixing band member 10, the buckle 8 may be hidden in the seat 2 and not easily located. The buckle 8, which has fallen off, cannot be coupled to the tongue member 7 unless the buckle 8 is pulled up on the seat surface of the seat 2.

With the seat belt device for a vehicle of the present embodiment, when the seat 2 is restored to the seating position, the buckle 8 is located at the initial position and therefore not caught. This allows an occupant to easily find the buckle 8 and to immediately pull out the buckle 8 so as to be coupled with the tongue member 7. This increases convenience for use.

Further, as illustrated in FIG. 2, the seat belt device for a vehicle of the present embodiment is provided with the auxiliary band member 11 having a loop shape.

This allows the buckle 8 to be held at a desired position in the longitudinal direction of the fixing band member 10.

Still further, the auxiliary band member 11 is made of a fabric material which is less elastic than the fixing band member 10 made of a rubber material. Therefore, a radial dimension of the loop is not expanded. This further makes it difficult for the buckle 8 to fall off from the loop of the auxiliary band member 11.

As illustrated in FIG. 4, when the buckle 8 is pulled forward F or diagonally upward, with reference to the vehicle, the fixing band member 10 is extended. At this time, the loop of the auxiliary band member 11 is not expanded and maintains holding the buckle 8. Accordingly, a position of the auxiliary band member 11, where the webbing 9 is inserted through the auxiliary band member 11, is not easily moved toward the base end 9a along the webbing 9.

When the buckle 8 is stopped from being pulled up forward F, with reference to the vehicle, the buckle 8 returns to the initial position by an elastic reaction force of the fixing band member 10. At this time, the buckle 8 is held in the loop of the auxiliary band member 11. Therefore, there is no risk of the buckle 8, which has fallen off, being caught between the seatback 3 and the seat cushion 4, as in a conventional case.

Further, as illustrated in FIG. 3, the stitched end 9c of the webbing 9 is located at the middle of the webbing 9 to face the buckle 8. The side edge 11c of the auxiliary band member 11 comes in contact with the stitched end 9c in a direction from the tip end 9b to the base end 9a of the webbing 9.

Thus, even when the auxiliary band member 11 slidably moved in a direction from the tip end 9b to the base end 9a of the webbing 9, the side edge 11c comes in contact with the step at the stitched end 9c to stop the movement. Accordingly, the auxiliary band member 11 cannot be slidably moved anymore so that the buckle 8 is stably held at a desired position.

Further, as illustrated in FIG. 1, the fixing band member 10 is provided at an angle to the lower edge 3a of the seatback 3.

Specifically, the fixing band member 10 is fixed to incline at a predetermined angle, with one end thereof stitched to the lower edge 3a and the other end thereof stitched to the periphery of the recess 3b, respectively, so as to be located higher with the decreasing distance to the side edge of the seatback 3.

In the present embodiment, the fixing band member 10 is set to incline upward at an angle of about 25 degrees, for example, but is not particularly limited thereto. The fixing band member 10 may be inclined at any angle in a range from about 5 to 85 degrees, for example, preferably in a range from about 20 to 70 degrees.

As illustrated in FIG. 1, the fixing band member 10 is stitched at one end to the lower edge 3a and at the other end to a corner of the periphery of the recess 3b. This gives the fixing band member 10 desired mounting rigidity.

Further, the fixing band member 10 can have a region thereof, where the buckle 8 is held by the auxiliary band member 11, set away above the lower edge 3a at any position from the lower edge 3a, inclining upward, to the periphery of the recess 3b.

Accordingly, the buckle 8 has an increased degree of freedom in selecting an arrangement position, to further improve convenience of use.

FIG. 5 illustrates a seat belt device for a vehicle of a modification of the present embodiment. An auxiliary band member 21 having a band shape is fixed to the seatback-facing surface 10a, at the middle position in the longitudinal direction, of the fixing band member 10, with a pair of ends in the longitudinal direction of the auxiliary band member 21 stitched at stitched parts 21a, respectively.

The auxiliary band member 21 forms a loop, together with a part of a side surface of the fixing band member 10. The loop is set to have a size which allows the webbing 9 coupled to the buckle 8 to be inserted therethrough, as with the embodiment illustrated in FIG. 4.

The auxiliary band member 21 of the modification illustrated in FIG. 5 has a band shape, and both ends thereof are respectively stitched at the stitched parts 21a to the fixing band member 10 for connection. The loop of the modification is formed by the auxiliary band member 21 having a band shape and a part between the stitched parts 21a on the seatback-facing surface 10a of the fixing band member 10.

Accordingly, the auxiliary band member 21 of the modification, together with the fixing band member 10, easily forms the loop which has size enough to insert the webbing 9 therethrough and to hold the buckle 8 at a desired initial position. Other structures and advantageous effects are the same as or equal to those of the vehicle seat belt device for a vehicle of the embodiment, and the descriptions thereof are omitted.

As described above, the seat belt device for a vehicle of the present embodiment holds the buckle 8 at an easy-to-use position, by the fixing band member 10 and the auxiliary band member 11. Further, even in a case where the seat 2 is deformed such as by folding, restoring the seat 2 to a seating position returns the buckle 8 to an initial position. Therefore, the buckle 8 does not fall off or get caught. Accordingly, advantageous effects in practical use are obtained such that the buckle 8 is held at an initial position to improve convenience of use.

The present disclosure is not limited to the above-described embodiments, and various modifications can be made. The above-described embodiments are exemplified for the purpose of illustrating the present disclosure, and the present disclosure is not necessarily limited to those having all the structures described above. Further, a part of a structure of an embodiment may be replaced with a structure of another embodiment, and a structure of an embodiment may be added with a structure of another embodiment. Alternatively, a structure of an embodiment may partly be deleted, or may be added or replaced with another structure. A conceivable modification to the embodiment described above is as follows, for example.

In the present embodiment, the fixing band member 10 is fixed at an angle, with one end stitched to the lower edge 3a and the other end stitched to the periphery of the recess 3b, but is not particularly limited thereto.

For example, the fixing band member 10 may be fixed at an angle, with the other end stitched to a side edge on either right or left side of the seatback 3. That is, an arrangement location, an angle, and a fixing method of the fixing band member 10 are not particularly limited to the present embodiment, as long as the fixing band member 10 is provided at an angle to the lower edge 3a of the seatback 3.

Further, the present disclosure may be applied, for example, to a so-called connect buckle, which extends from a ceiling above a rear seat and to which a tip end of a seat belt, used by an occupant seated in the center, is fixed.

What is claimed is:

1. A seat belt device for a vehicle, comprising:
a seat provided with a seatback and a seat cushion, and mounted on a floor;
a buckle arranged at a lower edge of the seatback and coupled to a tongue member of a seat belt;
a webbing having a base end thereof fixed to the floor, and a tip end thereof coupled to the buckle through between the seatback and the seat cushion;
a fixing band member arranged at a lower end of the seatback; and
an auxiliary band member arranged on the fixing band member and having the webbing, coupled to the buckle, inserted therethrough.

2. The seat belt device for a vehicle as claimed in claim 1, wherein the auxiliary band member has a loop shape.

3. The seat belt device for a vehicle as claimed in claim 1,
wherein a stitched end of the webbing is located on an outer surface at a middle of the webbing so as to face the buckle, and
the auxiliary band member is arranged between the stitched end and the buckle.

4. The seat belt device for a vehicle as claimed in claim 1, wherein the fixing band member is provided at an angle so as to be located higher with the increasing distance from the lower edge of the seatback toward a side edge of the seatback.

5. The seat belt device for a vehicle as claimed in claim 1, wherein the auxiliary band member is a member in a band shape whose both ends are connected to the fixing band member.
